(19) United States
(12) Patent Application Publication
(10) Pub. No.: US 2023/0106553 A1
(43) Pub. Date: Apr. 6, 2023

(54) Power Harness

(71) Applicants: Phyllis M. Lear, Natchitoches, LA (US); Ryan J. Hargroder, Lafayette, LA (US)

(72) Inventors: Phyllis M. Lear, Natchitoches, LA (US); Ryan J. Hargroder, Lafayette, LA (US)

(21) Appl. No.: 17/449,997

(22) Filed: Oct. 5, 2021

(51) Int. Cl. H01M 50/296; H01M 50/247

(52) U.S. Cl. CPC H01M 50/296; H01M 50/247

(57) ABSTRACT

The Power Harness improves the ergonomics and operation of battery operated power tools and electronic equipment by removing the weight of the rechargeable battery from the tool/device and relocating it to the back panel of a harness worn on the upper body of the operator/worker. Power tools/electrical equipment are connected to the harness battery pack via a coiled power cord plugged in to a connector located on the upper front of the harness. Because the battery is carried on the back of the operator/worker, a larger, longer-life battery, or batteries configured in parallel, is used, alleviating muscle fatigue often experienced when using power tools/electrical devices with batteries attached to the tool/device. The Power Harness allows for maneuverability in and accessibility to varying working environments (i.e., elevated towers, above-head construction, rural work sites, etc.). Battery packs and electrical connector arrays are assembled according to scope of service provided by industry/client.

### SPECIFICATIONS

### Background

The Power Harness improves the ergonomics and operation of battery operated power tools and electronic equipment by removing the weight of the rechargeable battery from the tool/device and relocating it to the back panel of a harness worn on the upper body of the operator/worker. Power tools/electrical equipment are connected to the Power Harness battery pack via a coiled power cord plugged-in to a connector located on the upper front of the harness. Because the battery is carried on the back of the operator/worker, a larger, longer-life battery, or batteries configured in parallel, is used, alleviating muscle fatigue often experienced when using power tools/electrical devices with batteries attached to the tool/device. The Power Harness allows for maneuverability in varying working environments (i.e., elevated towers, above-head construction, rural work sites, underwater, etc.). Battery packs and electrical connector arrays are provided by or assembled according to scope of service provided by industry/client.

### Brief Description

The Power Harness consists of an adjustable harness worn on the upper body, holding a heavy-duty, long-life, rechargeable battery pack with the capacity to operate power tools and electronic equipment. The removable battery pack is held and docked in a pocket located on the back panel of the harness. An encased electrical cord runs from the back battery dock, over the left shoulder, connecting to an array of electrical connectors located on the upper front of the harness. Power tools/electronic equipment are connected to the harness front using a coiled power cord. Electrical devices using USB connections can also be plugged in to USB ports. A spent battery pack can be replaced by a charged battery pack. Two heavy duty, metal D-rings on the front of the harness provide for clipping on additional tools and equipment. There is also a small pocket located on the front of the harness, below the array of electrical connectors, for holding small tools and hand-held electronic devices.

### DESCRIPTION OF DRAWINGS

FIG. 1. Line drawing with two views: A (front), and B (back) of the Power Harness.
View A. Front of harness indicating:
   1. connector array (supplied by or assembled according to scope of service provided by industry/client)
   2. encased electrical cord from the connector array over the left shoulder
   3. two (2) front adjustable clips for shortening/lengthening harness
   4. front pocket for holding small tools and hand-held electronic devices
   5. two (2) metal D-rings for attachment of additional tools/equipment.
View B. Back of the Power Harness indicating
   2. encased electrical cord from the battery dock over the left shoulder
   3. adjustable clips at the waist for personal fit of the harness.
      NOTE: These clip assemblages connect the back of harness to the front of the harness at the waist.
   6. battery and battery dock pocket with cover (battery dock supplied by or assembled according to scope of service provided by industry/client)

FIG. 2. Line drawing indicating how the Power Harness would fit on a user/operator of a tool/device with an example power tool connected via a coiled power cord to a 3-prong socket.

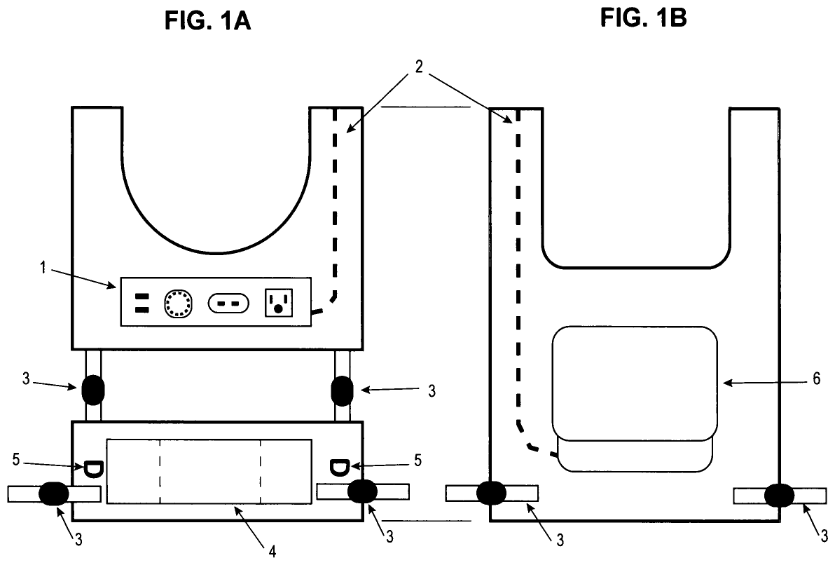

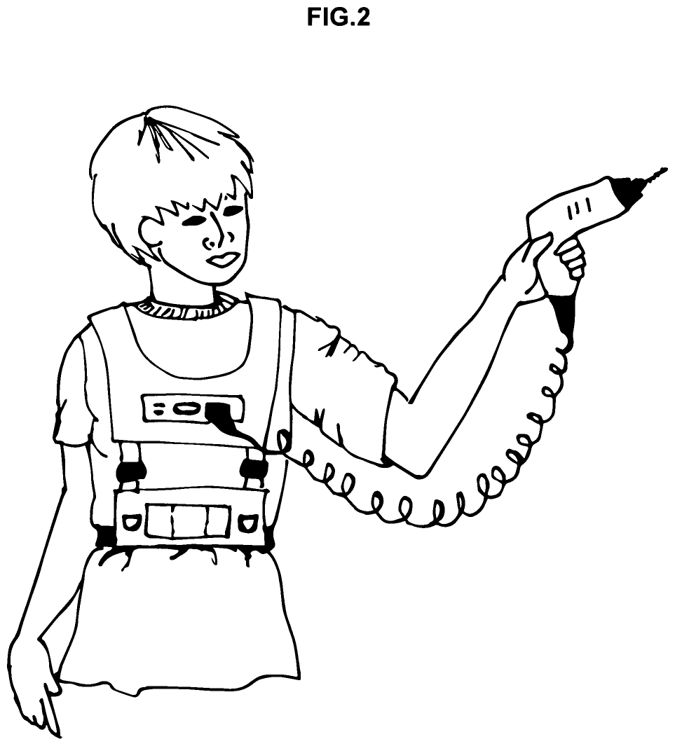

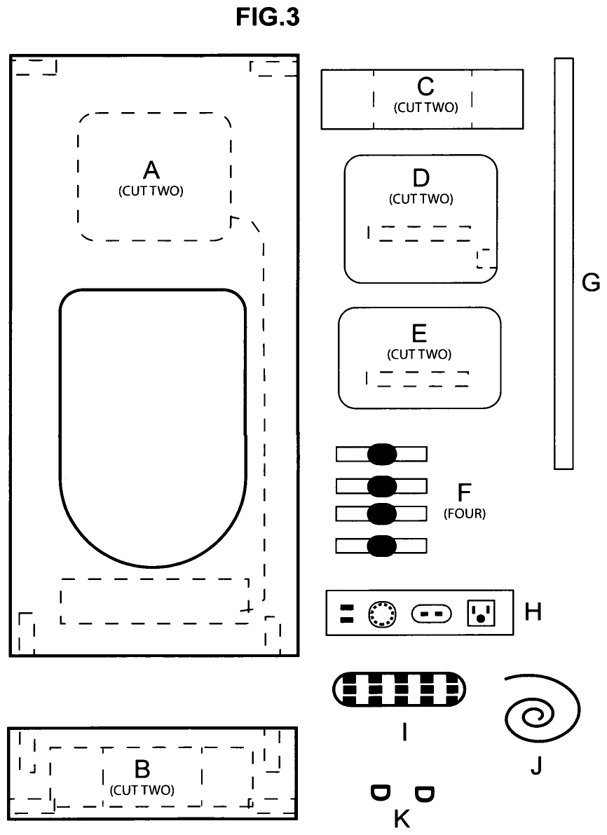

FIG. 3. Pattern and hardware
A. Front/back of harness (cut two)
B. Lower front panel of harness (cut two)
C. Front pocket (cut two)
D. Back Battery Pocket (cut two)
E. Back Battery Pocket Cover (cut two)
F. Fastener clips (four)
G. 2 cotton bias tape (Finish neckline)
H. Connector array (supplied by or assembled according to scope of service provided by industry/client)
I. Battery dock (provided by or assembled according to scope of service provided by industry/client)
J. Electrical wire (specifications according to scope of service provided by industry/client)
K. D-rings

### DETAILED DESCRIPTION

Manufacture of the Power Harness entails the procurement of materials; the cutting and sewing of the harness; the installation of the battery dock, socket/USB port array, and the electrical wiring of these two components per industry/client scope of service.

Materials List:
Heavy duty waxed cotton duck canvas
Heavy duty thread
Heavy duty cotton webbing—2 inch wide
Four 2-inch wide, extra thick military grade dual adjustable quick release clips
2 inch wide bias tape
Three (3) 2 inch wide heavy duty seamless cast solid D-rings
Battery dock for battery pack (provided by or assembled according to scope of service provided by industry/client)
Electrical wiring (provided by or assembled according to scope of service provided by industry/client)
Connector array (supplied by, purchased for, or assembled to industry/client scope of service)

Manufacturing Equipment:
Fabric cutting tools
Sewing machine
Electronic tools for assembling, installing, and testing electronic components to industry/client scope of service (battery dock, electrical wiring, connector array)

Manufacturing Process: (Refer to FIG. 3)
Cut cotton duck to pattern specifications.
Assemble 4 sets of 2-inch wide quick release clips and 2-inch heavy-duty, cotton webbing and.
Place the two A pieces one on top of the other with right sides together. Sew around the edge, using a ½ inch seam allowance, stopping and starting as indicated in on the pattern. Turn right-side out and press.
Construct casing and opening for J, the electrical wire, by sewing through both A pieces as indicated on the pattern. NOTE: The construction of the opening at the end meeting D, the battery pocket, is configured to scope of service provided by industry/client.
Place the two B pieces one on top of the other with right sides together. Sew around the edge, using a ½ in seam allowance, stopping and starting as indicated on the pattern. Turn right side out and press.
Insert and secure 2 inches of the ends each of F, the clip/webbing assemblages, between the two layers of sewn fabric of Pieces A and B at the eight (8) points indicated in on patterns.
Turn in the ½ inch seam allowances at each clip/webbing opening as indicated on A and B. Press into place.
Sew, ¼ inch from edge, around pieces A and B, permanently securing the clip/webbing assemblages and closing the eight (8) openings.
Reinforce each F, web/clip assemblages, by sewing an X within a rectangle at each of the eight (8) points where the clip/webbing assemblages meet the fabric.
Open the two clips at the waist to allow the harness to lay flat.
Front Pocket: Place the two C pieces on top of one another with right sides together, right sides facing each other. Sew ½ inch seam allowance around then turn right-sides out. Press.
Place sewn and pressed C (front pocket) on the front part of the harness as indicated on the pattern. Sew the pocket onto the front part of the harness ¼ inch from the sides and bottom edges. Leave the top open. Sew the pocket into parts as indicated on the pattern.
Battery pack pocket. Place the two D pieces on top of one another with right sides together, right sides facing each other. Sew ½ inch seam allowance around then turn right-sides out. Press.
Place and sew one side of 2-inch wide Velcro strip across D as indicated on the pattern.
Place sewn and pressed D (battery pack pocket) on the back part of the harness as indicated on the pattern. Be sure the Velcro side is facing out and away from the harness. Sew the pocket onto the back part of the harness ¼ inch from the sides and bottom edges. Leave the top open. Reinforce the corners. NOTE: I, the battery dock will be affixed to the bottom interior of this back pocket using fasteners prescribed by industry/client. Fashion an opening on the left side of the pocket for the attachment of electrical wiring I according to scope of service received from industry/client.
Place the two E pieces (battery pack pocket cover) on top of one another with right sides together. Sew ½ inch seam allowance around then turn right-sides out. Press.
Place and sew the other half of 2-inch wide Velcro strip across E as indicated on the pattern.
Place sewn and pressed E (battery pack pocket cover) above the top edge of D (battery pocket). Sew ¼ inch across the top edge. Reinforce the two corners.
Sew 2-inch cotton bias around the neck opening to finish raw edge.
Assemble and install H, the connector array, onto the upper front of the harness using fasteners prescribed by scope of service and/or client. Allow J, the connecting electrical wire, to extend out the left side of the socket/USB array.
Thread J, the electrical wire, through the casing from H, the connector array, to I, the battery dock.
Install I, the battery dock, in the back pocket of the harness with the connector for the electrical wire placed on the left side. Once the battery dock is installed in the back pocket, fashion an opening for the electrical wire connecting the battery dock to the connector array.

1. The Power Harness is an adjustable harness comprising: a back panel with a pocket housing a long-life battery and battery dock; a front panel with an array of connectors (outlets/sockets) that are connected to the back battery dock via encased electrical wiring running from the connector array, over the left shoulder to the back battery dock; adjustable clips located at the waist and chest for sizing; a front pocket for holding small electronic devices and tools; D-rings located on the front panel for carrying additional tools/equipment.

2. The Power Harness improves the ergonomics of battery operated power tools and electronic equipment by removing the weight of the rechargeable battery from the tool/device and relocating it to the back of a harness worn on the upper body of the operator/worker.

3. The Power Harness lessens muscle fatigue experienced by operators/workers using battery powered tools and electrical equipment by removing the battery's weight from the tool/device.

4. The Power Harness allows for extended usage time because power tools/devices are connected to a larger, longer-life battery, or batteries configured in parallel, via a short, coiled power cord plugged in to a connector located in an array on the upper front of the harness.

5. The Power Harness allows for accessibility to, and maneuverability in, varying working environments (i.e., elevated towers, above-head construction, rural work sites, underwater, etc.) due to lightened weight of tools/devices and extended usage time.
